(19) United States
(12) Patent Application Publication
(10) Pub. No.: US 2007/0272905 A1
(43) Pub. Date: Nov. 29, 2007

(54) Ergonomic Center Handle Fish Tape

(76) Inventors: Bernard J. Ziebart, Pewaukee, WI (US); David A. Huebschen, Monomonee Falls, WI (US)

Correspondence Address: Quarles & Brady, 411 E. Wisconsin Ave., Milwaukee, WI, 53202, US

(21) Appl. No.: 10/567,228

(22) PCT Filed: Aug. 6, 2004
(86) PCT No.: PCT/US04/25408

§ 371 Date: Oct. 13, 2006

Related U.S. Application Data
(60) Provisional application No. 60/493,670, filed on Aug. 8, 2003.

(51) Int. Cl. H02G 1/08

(52) U.S. Cl. 254/134.3 FT

(57) ABSTRACT

A fish tape reel has an ergonomic center handle disposed across the center opening of an annular, high-drop strength housing that defines a cavity containing a fish tape cassette. The interior of the cavity can have rib-like friction reducers against which the fish tape slides. Flat metal fish tape is wound around a hub of the cassette with one end secured to the cassette and the opposite end fed through an exit aperture of the housing. The cassette is rotatably mounted in the housing cavity by a retaining ring sonically welded to the housing. A handle mounted to the cassette facilitates rotating the cassette relative to the housing for winding and unwinding the fish tape. The ergonomic handle is positioned generally along a vertically center line of the housing in position for grasping with a straight wrist when winding and unwinding the fish tape.

### CROSS-REFERENCE TO RELATED APPLICATION

This application claims benefit to U.S. provisional application Ser. No. 60/493,670, filed Aug. 8, 2003.

### STATEMENT OF FEDERALLY SPONSORED RESEARCH OR DEVELOPMENT

Not applicable.

### BACKGROUND OF THE INVENTION

1. Technical Field

The present invention relates to fish tapes of the type used by electricians to pull wire through conduit or other spaces, and more particularly to the fish tape reel assembly.

2. Description of the Related Art

A fish tape is a stiff but bendable wire, flexible rod or flat tape typically used to install wire in conduit, through existing walls, under carpet, over dropped ceilings, or through other tight spaces. Because typical electrical wire is very flexible, pushing it through long lengths of conduit is virtually impossible. Pulling wire along the desired path is much more effective. In order to pull the wire, a fish tape, being more rigid than electrical wire, is first pushed along the desired path. Once an end of the fish tape reaches the end of the desired path, the electrical wire is attached to the fish tape end, and the fish tape is retrieved which pulls the wire with it.

The fish tape is typically coiled inside of a reel assembly. For example U.S. Pat. No. 4,092,780 has a generally annular tape receiving chamber bounded at its periphery by a pair of opposed lips, which separate to permit winding and unwinding of the fish tape in the chamber. A handle having a tape passage is mounted between the lips, which provides passage of the tape out of and into the receiving chamber. This reel arrangement makes it somewhat difficult to wind and unwind the tape. Given the relative rigid and springy characteristics of the fish tape, coiling the fish tape can require significant force and can be time consuming and frustrating, particularly if the tape binds inside of the reel. Moreover, initial assembly or reattachment of the fish tape to the reel may require the reel to be disassembled in order to anchor one end of the tape to an interior wall. And, once the tape coiled in the chamber the reel must be assembled (or reassembled) without the coil coming undone.

U.S. Pat. No. 6,224,038 provides a solution to the winding and assembly difficulties associated with conventional fish tape reels, as in the above mentioned patent. In this patent, the fish tape is contained in a cassette that loads easily into the main body of the reel. The cassette has its own handle for rotating the cassette relative to the reel body and thereby wind and unwind the tape. While this design provides significant benefits over other conventional fish tape reels, it lack ergonomic features that make it comfortable to operate.

One common problem with conventional fish tape reels is that the handle, as in U.S. Des. Pat. No. D408,749, is ordinarily a carrying handle for transporting the reel to and from a job site, for example, rather than being something to grip and brace the reel when unwinding, and especially, when winding the fish tape.

U.S. Pat. No. 6,016,609 discloses a purportedly ergonomic fish tape reel with a “pistol grip” handle. The pistol grip handle is beneficial because it permits the user to grasp the reel during the winding and unwinding processes with the user's wrist generally straight and in line with the forearm, thereby reducing strain on the user's wrist. However, the disclosed reel coils the fish tape in a cavity located horizontally behind the handle such that the reel would tend to cock back under the force of gravity and forces generated during the winding and unwinding processes such that user's wrist will have to overcome these forces, thereby straining the user's wrist.

U.S. Pat. No. 2,743,884 discloses a different approach to aiding the user in the winding process. In particular, this patent discloses a threader element that fits in the chamber between the opposite sides of the reel. The threader has an elongated body with a passageway through which the fish tape feeds into and out of the reel and a forward leaning handle extending up from the body. The threader is held fixed by the user and the rest of the reel is rotated by hand to wind the fish tape. The threader extends as a chord across an upper interior part of the reel diameter. By virtue of the force of gravity moving the reel downward and the spring force of the fish tape biasing the threader upward, the threader will assume this position during use almost in variably, with only slight difference in relative position. This location, in which the handle of the threader is positioned at a front side of the reel, is disadvantageous because the weight of the reel will tend to cause the wrist to cock backward, especially when winding the fish tape.

### SUMMARY OF THE INVENTION

The present invention is a fish tape reel assembly with a center handle design for holding the device in an ergonomic manner when winding and unwinding the fish tape.

In particular, the present invention provides an ergonomic fish tape reel assembly having a housing for a rotating fish tape cassette. The housing has a back wall and outer and inner peripheral walls extending axially from the back wall to define an outward facing annular cavity disposed about a central opening concentric with a center axis and bounded by the inner peripheral wall. A reel handle extends from the housing across the center opening. The cassette is rotatably mounted in the annular cavity for rotation about the center axis. It has an axially extending hub about which the fish tape is wound and a radially extending annular outer wall to which is mounted a cassette handle for manually rotating the cassette about the center axis relative to the housing. One end of the fish tape is secured to the cassette and an opposite end extends outside of the cassette through an exit aperture of the housing.

In preferred forms, the reel handle has a pistol grip configuration for grasping the reel assembly with an essentially straight wrist. The reel handle should have a grippable surface at least about three inches in length to allow all four fingers to grasp the reel handle comfortably. The reel handle preferably extends across the center opening along a slightly curved path essentially along a vertical center line of the housing so as to be somewhat concave toward a forward side of the center line where the exit aperture of the housing is located directing the fish tape along a feed direction essentially perpendicular to the reel handle. The grippable surface of the reel handle is a convex surface, preferably being a closed curvilinear path, such as circular or elliptical in cross-section.

The cassette is preferably rotatably mounted in the cavity of the housing by a retaining ring. The retaining ring has an axially extending inner peripheral wall that is sonically welded to the inner peripheral wall of the housing, and it has a radially extending annular outer wall disposed in an annular, outward facing recess of the outer wall of the cassette so as to overlap the outer wall of the cassette without inhibiting rotation of the cassette. The cassette handle is mounted to the outer wall of the cassette to extend axially parallel to the center axis so that the cassette can be rotated easily with one hand while the housing is supported by the reel handle. The fish tape is guided along the feed direction by a passageway in the housing extending tangentially from the annular cavity to the exit aperture.

The reel handle and the housing are preferably molded of an impact modified plastic as a monolithic structure. The cassette and retaining ring are separately molded impact modified plastic components, and the fish tape is a flat metal tape. The housing and retaining ring are preferably permanently joined using a sonic welding technique. The combination of the impact plastic and the sonic welding gives a preferred version of the assembly an improved drop strength compared to other fish tape devices on the market. Damage-free drops from heights of up to 24 feet on various hard surfaces have been achieved. Other fish tape devices having mechanical fasteners joining the housing parts can have significantly reduced drop strength, in some cases being unable to sustain falls from one-half the aforesaid height.

Another preferred feature of the fish tape reel assembly of the present invention is at least one friction reducing member to reduce sliding friction as the fish tape moves relative to the housing. The friction reducing member is preferably located at an interior (generally axial) surface of the outer peripheral wall of the housing against which the fish tape is biased by its spring rate when wound in the cassette. The friction reducing member should define a contact area with the fish tape of less then the surface area of the outer peripheral wall of the housing. In one preferred form, there are a plurality of radially inwardly extending rib-like members spaced apart along the interior surface of the outer peripheral wall of the housing. The ribs can be formed integrally with the housing and can have a smooth convex surface essentially providing a thin, preferably line contact, contact surface with the fish tape to ease sliding. This reduces the force needed to wind and unwind the fish tape, and thereby the strain on the user.

These and still other advantages of the invention will be apparent from the detailed description and drawings. What follows is a preferred embodiment of the present invention. To assess the full scope of the invention the claims should be looked to as the preferred embodiment is not intended as the only embodiment within the scope of the invention.

### BRIEF DESCRIPTION OF THE DRAWINGS

FIG. 1 is a front perspective view of an ergonomic center handle fish tape reel assembly according to the present invention;

FIG. 2 is a rear perspective view thereof;

FIG. 3 is an exploded front perspective view thereof;

FIG. 4 is a reverse exploded rear perspective view thereof;

FIG. 5 is a front plan view thereof;

FIG. 6 is a rear plan view thereof;

FIG. 7 is a sectional view of the reel assembly taken along line 7-7 of FIG. 6;

FIG. 8 is an end view of the reel assembly;

FIG. 9 is a sectional view taken along line 9-9 of FIG. 8 showing the fish tape wound inside of a fish tape cassette of the reel assembly; and

FIG. 10 is an enlarged partial sectional view taken along arc 10-10 of FIG. 9 detailing anchoring of an end of the fish tape to the cassette.

### DETAILED DESCRIPTION OF THE PREFERRED EMBODIMENT

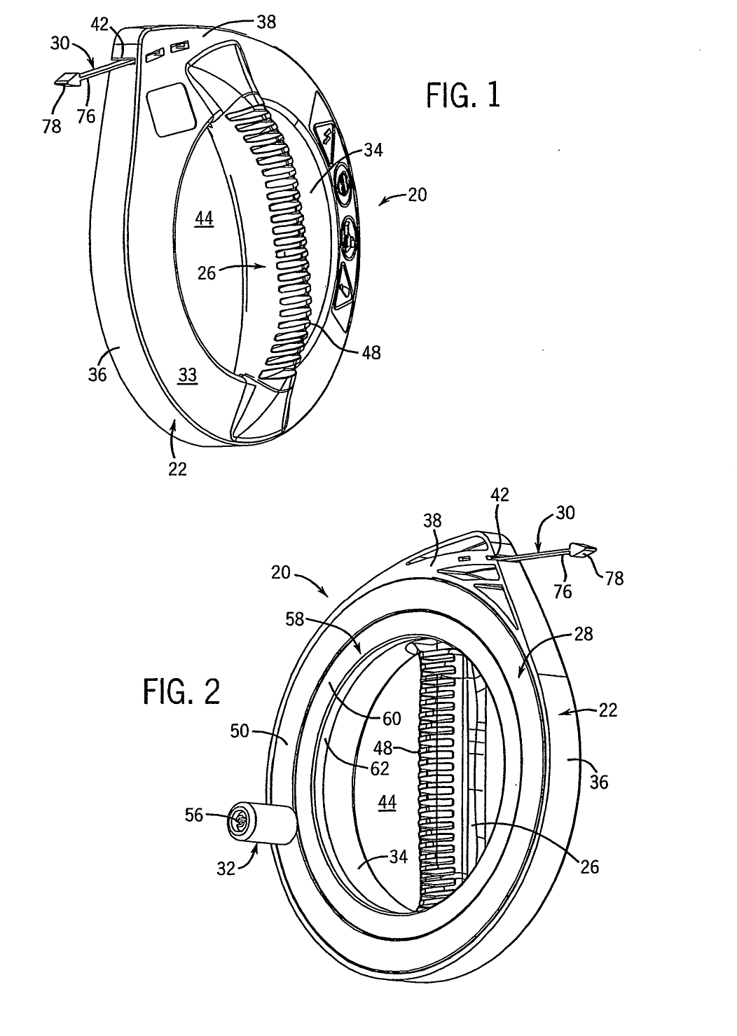

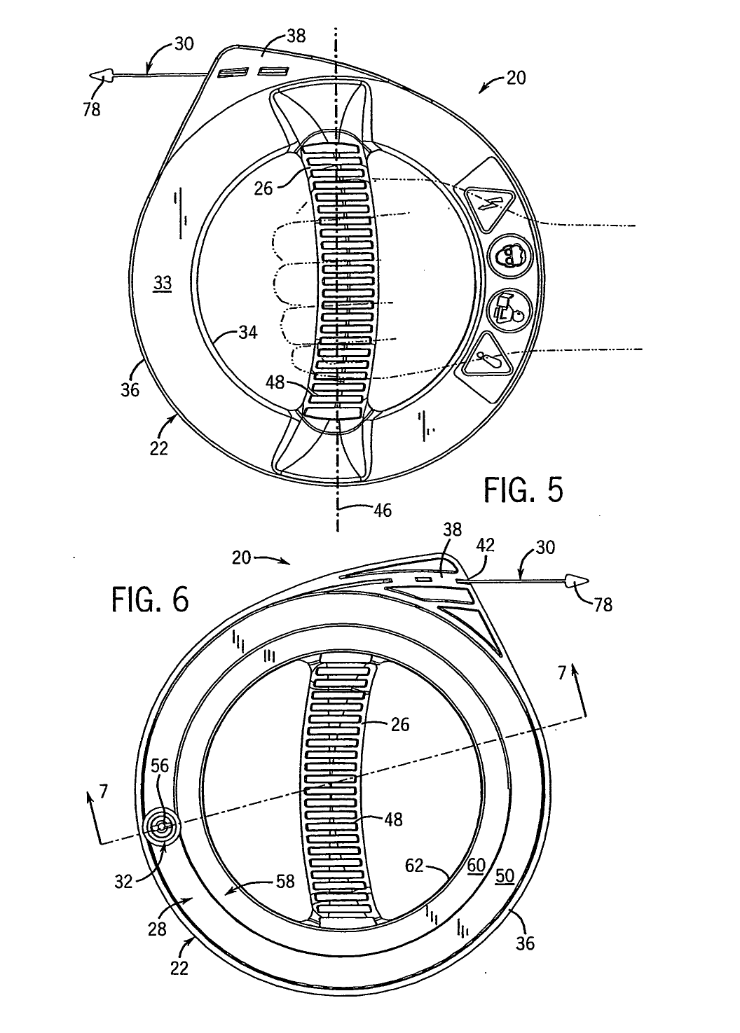

Referring to FIGS. 1-2, 5-6 and 8, a fish tape reel assembly 20 has a housing 22 with an annular cavity 24 formed therein, and an integral reel handle 26. A fish tape cassette 28 is mounted in the cavity 24 so as to be rotatable about a center axis 29. The cassette 28 contains fish tape 30 and has a cassette handle 32. A user rotates the cassette 28 to deploy or retrieve the tape 30. Preferably, the housing 22 and cassette 28 are formed from molded plastic, such as impact modified ABS, using methods known in the art, such as injection molding.

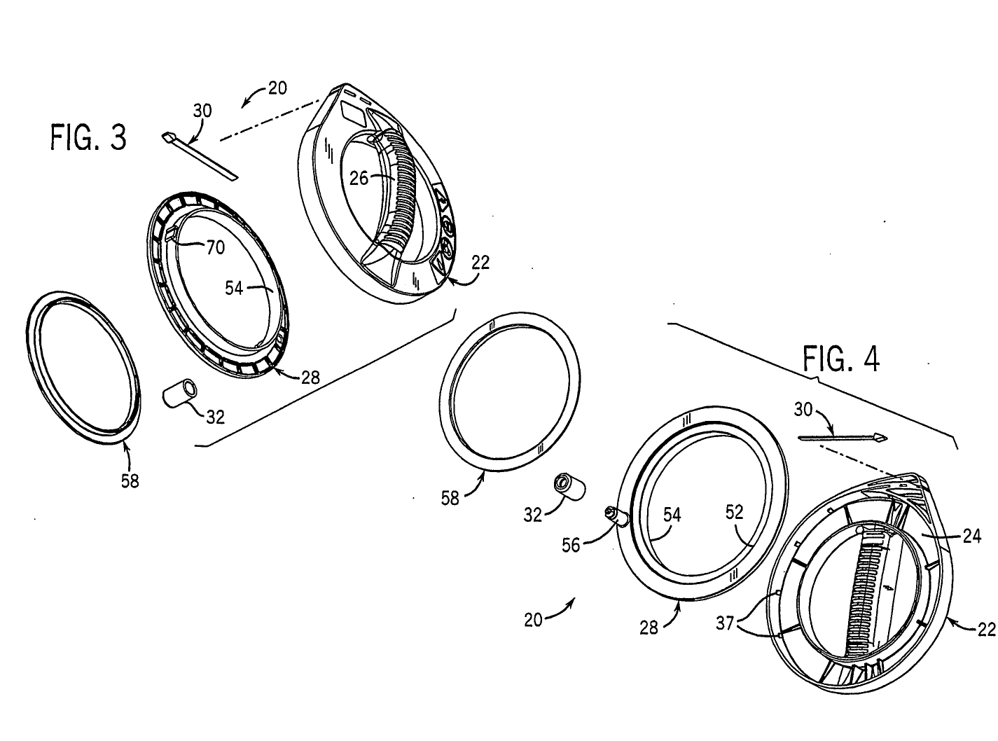

Referring now to FIGS. 3, 4 and 7, the housing 22 receives the cassette 28 in the annular cavity 24, which is defined by a generally annular, and somewhat outwardly tapering back wall 33 and inner 34 and outer 36 peripheral walls extending substantially parallel to the center axis 29. The outer peripheral wall 36 extends slightly further in the axial direction than the inner peripheral wall 34. As shown in FIGS. 4, 7 and 9, a plurality of friction reducing ribs 37 are formed integrally with an interior surface of the outer peripheral wall 36 to reduce sliding friction as the fish tape 30 moves relative to the housing 20 as it is wound and unwound. The ribs 37 are located at the outer peripheral wall 36 because the spring rate of the fish tape 30 tends to bias it radially outward when wound in the cassette 28. The ribs 37 define a contact area with the fish tape 30 of less then the surface area of the outer peripheral wall 36, thereby reducing friction. In the preferred form shown, the ribs 37 define a smooth, convex surface extending radially inward. The convex surface essentially provides a thin, preferably line contact, contact surface with the fish tape 30, again to minimize sliding friction as the fish tape 30 is wound and unwound. The resulting reduction in the force needed to wind and unwind the fish tape reduces the strain on the user. While integral, convex ribs have been shown and described herein, it should be noted that one or more separate or integral friction reducers of different configuration may be used, provided the sliding friction is less than it otherwise would have been between the fish tape 30 and the outer peripheral wall 36. One or more elements made of a more lubricious material or having a lesser contact surface area can be used to achieve this goal.

The housing 22 also defines a generally triangular head section 38, in part defined by the outer peripheral wall 36, through which a passageway 40 extends tangentially from the annular cavity 24 to an exit aperture 42 which guides the fish tape along the intended feed direction.

The housing 22 has an integral reel handle 26 extending across the circular opening 44 at the interior of the inner peripheral wall 34 generally along a vertical center line 46 of the reel assembly 20. More specifically, the reel handle 26 arches somewhat to be axially offset from the back wall 33 of the housing 22. The reel handle 26 is also ergonomically contoured along its length so as to be somewhat concave toward the forward side of the center line 46 at which the exit aperture 42 of the housing 22 is disposed, being generally convex at the opposite side. The reel handle 26 is generally round (circular, elliptical, etc.) in cross-section and defined by a plurality of spaced apart ribs 48 formed to reduce the material required to form the reel handle 26 without significantly reducing its structural integrity. The length of the reel handle 26, at least within the inner peripheral wall 34 of the housing 22, should be sufficient to allow the reel handle 26 to be grasped comfortably between all four fingers and the palm. This distance is generally about 4-5 inches and preferably at least about 3 inches.

The contour, length and location on the housing 22 all contribute to making the reel handle 26 ergonomic and comfortable to hold when using the device. The reel handle 26 is disposed along the vertical center line 46 of the housing 22 as oriented when the user grasps the handle with one hand having a straight wrist and forearm, generally parallel to the horizon as well as the feed direction of the fish tape 30. Holding the reel assembly 20 in this way reduces strain on the wrist and hand. And, since the reel handle 26 is generally along the vertical center line 46 the weight of the reel assembly 20 is generally distributed evenly about the user's hand such that the reel assembly 20 does not tend to bend or cock back the user's wrist under gravity with the user's wrist in a generally straight, horizontal position. Moreover, as will be described below, the fish tape 30 is wound into the cassette 28, in a counter-clockwise direction viewed from the face of the cassette 28, such that the force required to wind the fish tape 30 will tend to seat the reel handle 26 straight back into the user's palm, rather than away or at an angle thereto. This helps the user to maintain a firm grip without undue strain.

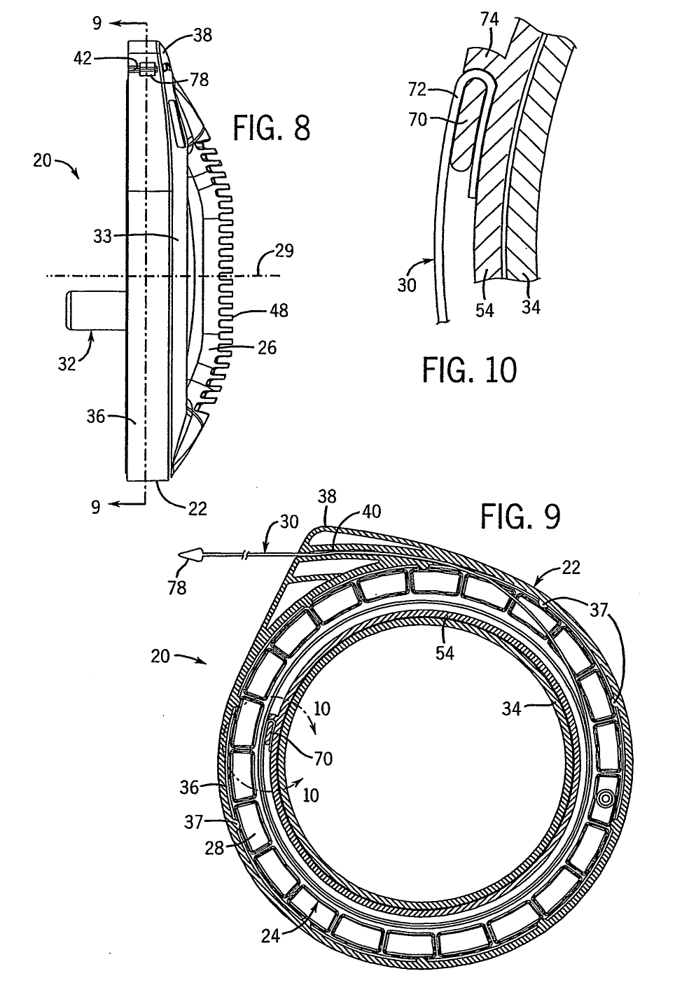

As shown in FIG. 9, the fish tape 30 is fed into the passageway 40 when the cassette 28 is mounted into the cavity 24, and it exits through the exit aperture 42 when the fish tape 30 is unwound from the cassette 28. By guiding the fish tape 30 along a feed direction substantially perpendicular to the reel handle 26 and parallel to the ground and the user's forearm less twisting torque is realized by the user's hand and wrist, thereby further contributing to the ergonomic attributes of the reel handle 26.

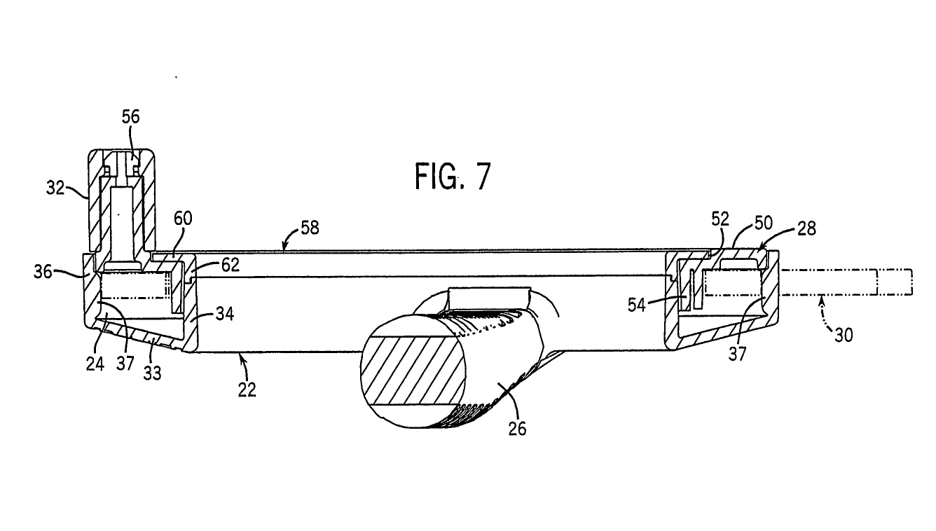

Referring now to FIGS. 2-4, 7 and 9, the cassette 28 is rotatably mounted in the housing cavity 24, preferably with the fish tape 30 wound thereon. The cassette 28 includes an annular outer wall 50 with a recess 52 adjacent an axially extending inner peripheral wall 54, about which the fish tape 30 is wound, which fits just inside of the inner peripheral wall 34 of the housing 22 so as to enclose the cavity 24 of the housing 22. The outer wall 50 also includes an integral mounting post 56 extending axially in a direction away from the housing 22 on which the cassette handle 32 mounts in a snap fit, as shown in FIG. 7. The cassette 28 is retained in the housing cavity 24 by a retaining ring 58 with an annular wall 60 disposed in the recess 52 so as to be generally flush with the outer wall 50 of the cassette 28. The retaining ring 58 also has an inner peripheral wall 62 of the same inner diameter and extending axially to abut the inner peripheral wall 34 of the housing 22 to which is permanently fixed to the housing 22, as shown in FIG. 7. The retaining ring 58 is sized so as retain the cassette 28 without inhibiting its rotation within the annular cavity 24. The housing 22, cassette 28 and retaining ring 58 are separately molded impact modified plastic components. The housing 22 and retaining ring 58 are preferably permanently joined using a sonic welding technique. In particular, the inner peripheral wall 62 of the retaining ring 58 abuts and is fused to the inner peripheral wall 34 of the housing 22, again as shown in FIG. 7.

The combination of the impact plastic and the sonic welding gives a preferred version of the assembly an improved drop strength compared to other fish tape devices on the market. Damage-free drops from heights of up to 24 feet on various hard surfaces have been achieved. Other fish tape devices having mechanical fasteners joining the housing parts can have significantly reduced drop strength, in some cases being unable to sustain falls from one-half the distance from which the present device can be dropped.

The fish tape 30 is preferably an elongated flat metal or fiberglass tape wrapped around the cassette 28. Although a flat tape is preferred, any shaped tape, such as a round tape, may be used without departing from the scope of the present invention. Referring to FIGS. 3, 9 and 10, at the interior of the inner peripheral wall 58 of the cassette 28 is anchor feature 70 for securing one end 72 of the fish tape 30 to the cassette to prevent it from completely slipping out of the reel assembly 20. The fish tape end 72 is bent backward in a U-shape and looped around the anchor 70. A wall 74 spaced close to the anchor 70 prevents the fish tape 30 from slipping off of the anchor 70. A free end 76 of the fish tape 30 extends from the exit aperture 42 and has an enlarged end piece 78 affixed thereto, or is bent in some way, to prevent the free end 76 from entering the interior of the housing 22.

In use, the fish tape 30 is dispensed from the cassette 28 by pulling the free end 76 away from the housing 22. The free end 76 of the fish tape 30 is guided along the desired path by the user. The fish tape 30 is wound back onto the cassette 28 by grasping the reel handle 26 with, for example, a left hand and holding the reel assembly 20 generally stationary with the wrist held straight and the forearm parallel to the ground. Then, the cassette handle 32 is grasped with the other hand and moved in a circular path in a winding direction, which is preferably bringing the cassette handle 32 toward the user's body at the top of the stroke, counterclockwise in the drawings.

It should be appreciated that merely a preferred embodiment of the invention has been described above. However, many modifications and variations to the preferred embodiment will be apparent to those skilled in the art, which will be within the spirit and scope of the invention. Therefore, the invention should not be limited to the described embodiment. To ascertain the full scope of the invention, the following claims should be referenced.

What is claimed is:

1. An ergonomic fish tape reel assembly, comprising:
a housing having a back wall and outer and inner peripheral walls extending generally axially from the back wall to define an outward facing annular cavity disposed about a central opening concentric with a center axis and bounded by the inner peripheral wall;
a reel handle extending from the housing across the center opening;
a cassette rotatably mounted in the annular cavity for rotation about the center axis, the cassette having an axially extending hub and a radially extending annular outer wall;
a cassette handle mounted to the cassette outer wall for manually rotating the cassette about the center axis relative to the housing; and
a fish tape wound around the cassette hub within the annular cavity of the housing and having one end secured to the cassette and an opposite end extending outside of the cassette through an exit aperture of the housing.

2. The reel assembly of claim 1, wherein the reel handle has a pistol grip configuration for grasping the reel assembly with a straight wrist in a generally horizontal position with the fish tape extending from the housing generally horizontally.

3. The reel assembly of claim 2, wherein the reel handle has a grippable surface at least three inches in length.

4. The reel assembly of claim 2, wherein the housing has a vertical center line perpendicular to and intersecting the center axis and wherein the reel handle essentially extends along the center line.

5. The reel assembly of claim 4, wherein the exit aperture is located at a forward side of the center line.

6. The reel assembly of claim 5, wherein the exit aperture directs the fish tape in a feed direction essentially perpendicular to the reel handle.

7. The reel assembly of claim 2, wherein the reel handle extends across the center opening in a curvilinear path.

8. The reel assembly of claim 7, wherein the reel handle is concave toward the forward side of the center line.

9. The reel assembly of claim 2, wherein at least a portion of the reel handle defines a convex surface.

10. The reel assembly of claim 9, wherein the convex surface defines a closed curvilinear path.

11. The reel assembly of claim 2, wherein the reel handle and the housing are formed as a monolithic structure.

12. The reel assembly of claim 11, wherein the reel handle and the housing are molded of an impact modified plastic.

13. The reel assembly of claim 1, wherein the cassette handle is mounted to the outer wall of the cassette to extend axially parallel to the center axis.

14. The reel assembly of claim 1, further including a retaining ring sonically welded to the housing to rotatably retain the cassette.

15. The reel assembly of claim 1, further including a retaining ring having an axially extending inner peripheral wall and a radially extending annular outer wall, the inner peripheral wall being fixedly mounted to the housing and the outer wall being disposed to overlap the outer wall of the cassette without inhibiting rotation of the cassette.

16. The reel assembly of claim 15, wherein the retaining ring inner peripheral wall is permanently attached to the housing inner peripheral wall.

17. The reel assembly of claim 16, wherein the outer wall of the cassette defines an annular recess facing outward adjacent the inner peripheral wall of the cassette in which the outer wall of the retaining ring is disposed.

18. The reel assembly of claim 1, wherein the housing defines a passageway extending tangentially from the annular cavity to the exit aperture for guiding the fish tape along a feed direction.

19. The reel assembly of claim 1, wherein the housing and reel handle are molded together of an impact modified plastic.

20. The reel assembly of claim 1, wherein the fish tape is a flat metal tape.

21. The reel assembly of claim 1, wherein the outer peripheral wall of the housing has an interior surface with at least one friction reducing member to reduce sliding friction as the fish tape moves relative to the housing.

22. The reel assembly of claim 21, wherein there are a plurality of such friction reducing members spaced apart along the interior surface of the outer peripheral wall of the housing.

23. The reel assembly of claim 22, wherein the friction reducing members are ribs formed integrally with the housing and extending radially inwardly from the outer peripheral wall of the housing.

24. The reel assembly of claim 23, wherein the ribs define a convex surface.

25. The reel assembly of claim 24, wherein the fish tape engages the ribs at the apex of the convex surface in essentially line contact.

26. The reel assembly of claim 21, wherein the at least one friction reducing member defines a contact area with the fish tape of less then a surface area of the outer peripheral wall of the housing.

27. A center handle fish tape reel assembly, comprising:
a housing defining an annular cavity about a central opening;
a reel handle fixed with respect to the housing and extending across the center opening of the housing; and
a fish tape disposed in the annular cavity and extending through an exit aperture of the housing having an inner end secured to a reel member rotatable with respect to the housing for winding and unwinding the fish tape.

28. The apparatus of claim 27, wherein the reel member is a cassette onto which the fish tape is mounted.

29. The apparatus of claim 28, wherein the cassette forms part of the exterior of the housing.

30. The apparatus of claim 29, further including a handle mounted to the cassette for rotating the cassette relative to the housing.

31. The apparatus of claim 27, wherein the reel handle has a pistol grip configuration for grasping the reel assembly with a straight wrist in a generally horizontal position with the fish tape extending from the housing generally horizontally.

32. The apparatus of claim 31, wherein the reel handle has a grippable surface at least three inches in length.

33. The apparatus of claim 31, wherein the housing has a vertical center line perpendicular to and intersecting a center axis about which the center opening is concentric and wherein the reel handle essentially extends along the center line.

34. The apparatus of claim 33, wherein the exit aperture is located at a forward side of the center line to direct the fish tape in a feed direction essentially perpendicular to the reel handle.

35. The apparatus of claim 27, wherein the reel handle extends across the center opening in a curvilinear path.

36. The apparatus of claim 35, wherein the reel handle is concave toward the forward side of the center line.

37. The apparatus of claim 27, wherein the reel handle and the housing are formed as a monolithic structure of impact modified plastic.

38. A center handle fish tape reel assembly, comprising:
a housing defining an aperture in communication with an annular cavity disposed about a central opening and including at least one friction reducing member at an interior surface within the annular cavity for abutting a fish tape housed in the annular cavity;
a reel handle fixed with respect to the housing and extending across the center opening of the housing; and
a reel member rotatably mounted to the housing to advance or withdraw the fish tape through the aperture in the housing.
